(19) United States
(12) Patent Application Publication
(10) Pub. No.: US 2024/0127522 A1
(43) Pub. Date: Apr. 18, 2024

(54) MULTI-MODAL THREE-DIMENSIONAL FACE MODELING AND TRACKING FOR GENERATING EXPRESSIVE AVATARS

(71) Applicant: Microsoft Technology Licensing, LLC, Redmond, WA (US)

(72) Inventors: Harpreet Singh SAWHNEY, Kirkland, WA (US); Benjamin Eliot LUNDELL, Seattle, WA (US); Anshul Bhavesh SHAH, Baltimore, MD (US); Calin CRISTIAN, Iasi (RO); Charles Thomas HEWITT, Cambridge (GB); Tadas BALTRUSAITIS, Cambridge (GB); Mladen RADOJEVIC, Belgrade (RS); Kosta GRUJCIC, Belgrade (RS); Ivan STOJILJKOVIC, Belgrade (RS); Paul Malcolm MCILROY, Cambridge (GB); John Ishola OLAFENWA, London (GB); Jouya JADIDIAN, Los Gatos, CA (US); Kenneth Mitchell JAKUBZAK, Lynnwood, WA (US)

(73) Assignee: Microsoft Technology Licensing, LLC, Redmond, WA (US)

(21) Appl. No.: 18/062,239

(22) Filed: Dec. 6, 2022

(30) Foreign Application Priority Data
Oct. 13, 2022 (RO) A-2022-00630

(51) Int. Cl. G06T 13/40; G06T 17/00; G06V 40/16

(52) U.S. Cl. CPC G06T 13/40; G06T 17/00; G06V 40/174

(57) ABSTRACT

Examples are disclosed that relate to generating expressive avatars using multi-modal three-dimensional face modeling and tracking. One example includes a computer system comprising a processor coupled to a storage system that stores instructions. Upon execution by the processor, the instructions cause the processor to receive initialization data describing an initial state of a facial model. The instructions further cause the processor to receive a plurality of multi-modal data signals. The instructions further cause the processor to perform a fitting process using the initialization data and the plurality of multi-modal data signals. The instructions further cause the processor to determine a set of parameters based on the fitting process, wherein the determined set of parameters describes an updated state of the facial model.

### CROSS REFERENCE TO RELATED APPLICATIONS

This application claims priority to Romanian Patent Application Serial Number a-2022-00630, filed Oct. 13, 2022, the entirety of which is hereby incorporated herein by reference for all purposes.

### BACKGROUND

A virtual avatar is a graphical representation of a user. The avatar can take a form reflecting the user's real-life self or a virtual character with entirely fictional characteristics. One area of study includes three-dimensional computer models capable of animated facial expressions for use in various virtual reality/augmented reality/mixed reality (VR/AR/MR) applications. Of great interest is the ability to adapt the user's facial expressions to animate the computer model in a similar capacity. Different motion capturing and computer vision techniques have been implemented to fit a user's facial expressions to rigged computer models to perform the desired animations. For example, landmark fitting techniques have been proposed to reconstruct user's faces into three-dimensional morphable facial models.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to generating expressive avatars using multi-modal three-dimensional face modeling and tracking. One example includes a computer system comprising a processor coupled to a storage system that stores instructions. Upon execution by the processor, the instructions cause the processor to receive initialization data describing an initial state of a facial model and to receive a plurality of multi-modal data signals. A fitting process is performed using the initialization data and the plurality of multi-modal data signals. The fitting process is performed by simulating a measurement using the initialization data and comparing the simulated measurement with an actual measurement derived from the plurality of multi-modal data signals. The initialization data is updated based on the comparison of the simulated measurement and the actual measurement. The instructions cause the processor to determine a set of parameters based on the fitting process, the determined set of parameters describing an updated state of the facial model.

### BRIEF DESCRIPTION OF THE DRAWINGS

FIG. 1 shows a schematic view of an example computing system comprising a computing device configured to perform a multi-modal three-dimensional (3D) face modeling and tracking (MMFMT) process for determining a facial expression.

FIG. 2 schematically illustrates a diagram showing an example process of using multi-modal data signals from a head-mounted display to generate an expressive 3D facial model.

FIG. 3 schematically illustrates a diagram showing an example process of determining expression parameters for a 3D face at a given time instant using data signals from eye cameras, antennas, and a microphone.

FIG. 4 shows an example wearable device that includes a plurality of antennas.

FIG. 5 shows an example MMFMT fitter module implementing a parallel plate capacitor forward model.

FIG. 6 shows an example MMFMT fitter module implementing an eye camera forward model.

FIG. 7 shows an example MMFMT fitter module implementing a fitting process for audio data signals.

FIG. 8 shows a flow diagram illustrating an example method for generating an expressive facial model using an MMFMT process.

FIG. 9 schematically shows an example computing system that can enact one or more of the methods and processes described above.

### DETAILED DESCRIPTION

Many techniques have been proposed for 3D facial modeling and reconstruction based on a user's face to create expressive avatars for various VR/AR/MR applications. Some such techniques include recording and tracking a user's face to determine various facial landmarks. The facial landmarks can be mapped to a 3D facial model to enable animation of the model through the tracking of the movements of the facial landmarks across a period of time. The use of additional inputs, such as depth imaging or differentiable rendering techniques, can also be implemented to more accurately reconstruct the user's face. However, these techniques are constrained in their range of applications. For example, VR/AR/MR applications often favor simplistic hardware implementations and, as such, may lack the ability to distinguish enough facial landmarks to reconstruct a 3D facial model within an acceptable level of accuracy. Specifically, wearable devices for VR/AR/MR applications, such as smart eyeglasses or goggles, may not include cameras for recording the entirety of the user's face and, as such, may lack the ability to distinguish enough facial landmarks to create expressive facial models.

In view of the observations above, examples related to multi-modal 3D face modeling and tracking for generating expressive avatars are disclosed. Three-dimensional face modeling and tracking techniques in accordance with the present disclosure utilize input data from multiple different sensors to implement a multi-modal framework for creating expressive 3D facial models. For example, multi-modal 3D face modeling and tracking techniques can utilize multiple different sensor devices, each providing one or more input signals and/or measurements for a user's face to detect, model, track, and/or animate a three-dimensional face model graphically as an avatar. In some examples, three-dimensional face modeling and tracking techniques create 3D vertices based on a user's face and apply transformations to the vertices from a neutral face to depict expressions on a digital face model (e.g., an avatar representation of the user's face). In some implementations, the 3D vertices of the face are generated on a per-instance basis using 3D modeling from multiple modality signals, and the vertices are tracked over time to create expressive animations.

Generally, the data signal from an individual sensor typically found on a wearable device for VR/AR/MR applications is inherently noisy and fails to provide a holistic view of the user's facial expression. Combining data signals from multi-modal sources provides for an improved framework for predicting the user's facial expression. The framework may utilize sensors that have complementary properties with one another based on their associated correlations with the user's facial expression. Different types of sensors and their associated data signals can be implemented in the multi-modal framework. In some implementations, capacitance values measured from inductive/capacitive antennas on the wearable device are used in conjunction with image data of the user's eye(s) and audio data to determine the user's facial expression. Various configurations of antenna circuits can be utilized, including LC oscillators and RC circuits.

In some implementations, the framework utilizes deep learning techniques and forward modeling to perform a parametric fitting process that translate the multi-modal data signals into a set of parameters or expression code that can be used to generate an expressive 3D facial model. The forward model takes in a set of initialization parameters defining a face and simulates measurements related to the data signals utilized. The actual measurements from the data signals are compared to the simulated measurements to compute a loss. The parameters are adjusted based on the computed loss, and the process continues iteratively for a predetermined number of iterations or until a loss criterion is reached. The process outputs a set of parameters that can be used to generate the expressive 3D facial model. With the use of multi-modal data signals, the measurements coming from the varied sensors are provided with different units and different scales. As such, the loss functions utilized in the deep learning techniques can be designed to account for the respective data measurement types of the data signals. These and other MMFMT techniques are discussed below in further detail.

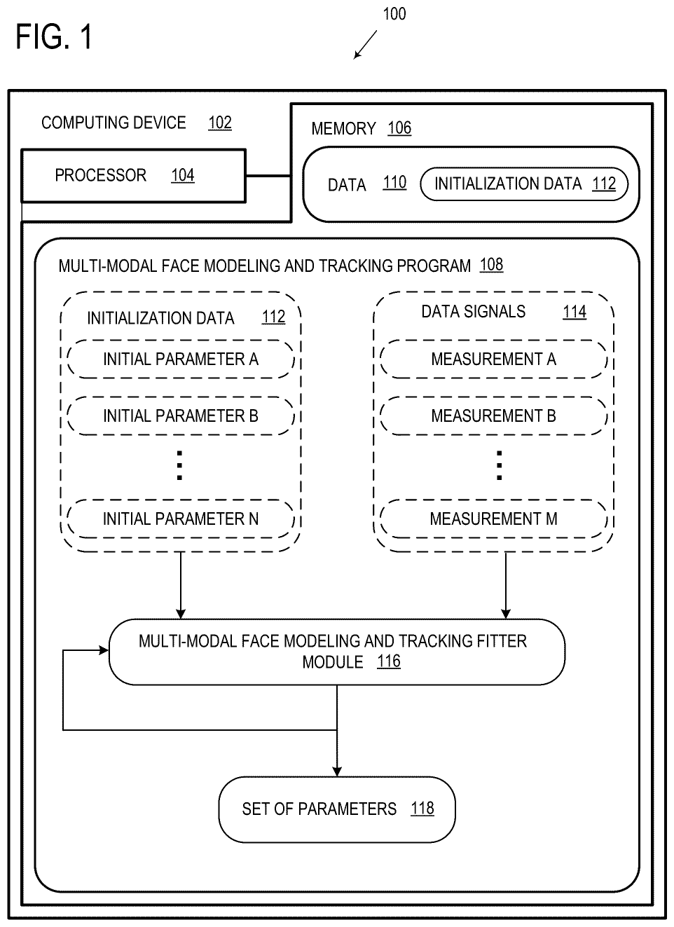

FIG. 1 shows a schematic view of an example computing system 100 having a computing device 102 configured to perform an MMFMT process for determining a facial expression in accordance with an implementation of the present disclosure. As shown, the computing device 102 includes a processor 104 (e.g., one or more central processing units, or “CPUs”) and memory 106 (e.g., volatile and non-volatile memory) operatively coupled to each other. The memory 106 stores an MMFMT program 108, which contains instructions for the various software modules described herein for execution by the processor 104. The memory 106 also stores data 110 for use by the MMFMT program 108 and its software modules.

Upon execution by the processor 104, the instructions stored in the MMFMT program 108 cause the processor 104 to retrieve initialization data 112 from data 110 stored in memory 106 for use by the MMFMT program 108. The initialization data 112 provides information of an initial state that defines a parametric model of the user's head. For example, the initialization data 112 can include data describing the expression of an initial 3D facial model. The initialization data 112 can also include data describing the identity of the initial 3D facial model, such as information regarding head shape, size, etc. The initialization data 112 can also include data describing the pose of the initial 3D facial model, such as information regarding the rotations and translations for the head, neck, and eyes of the initial 3D facial model. In some implementations, a zero expression facial model is utilized as the initial facial model. In some implementations, the initial 3D facial model is generated using a learning process, such as through the use of transformers or long short term memory neural networks.

The instructions stored in the MMFMT program 108 also cause the processor 104 to receive data signals 114 from various external sensors. As described above, different types of data signals 114 can be received. The types of sensors implemented depend on the data signals for which the MMFMT program 108 is configured. In some example implementations, the sensors implemented include sensors located on a wearable device, such as an antenna, an eye camera, a microphone, etc. Capacitance values can be received from antennas located on the wearable device. Different numbers of antennas can be utilized depending on the application. In some implementations, a wearable device having at least eight antennas is utilized. In other examples, a wearable device having fewer than eight antennas may be used. Audio data can be received from a microphone or any other appropriate type of transducer devices. Image data of the user's eye(s) can be received from a camera or any other appropriate type of optical recording devices.

The MMFMT program 108 includes an MMFMT fitter module 116 that receives the initialization data 112 and data signals 114 as inputs. The received data signals 114 can be converted into an appropriate data format before they are fed into the MMFMT fitter module 116. For example, in some implementations, the data signals 114 include image data of a user's eye(s). Landmarks can first be determined from the image data using a detector module for determining eye landmarks, and the landmark information are then fed into the MMFMT fitter module 116. In another example, audio data can be converted into an expression parameter using an audio-to-facial model module, and the audio expression parameter is fed into the MMFMT fitter module 116.

The MMFMT fitter module 116 performs a parametric fitting process to find a set of parameters 118 that can be used to generate an expressive 3D facial model. The MMFMT fitter module 116 takes the parameters describing an initial state of the facial model and simulate measurements related to the sensors utilized. The fitting process uses an iterative loop to find a set of parameters that produces simulated measurements close to the actual measurements (ground truth) of the data signals. For example, given sensor readings m and a deterministic function ƒ:Φ→m, the fitting process attempts to find a set of parameters Φ* such that ƒ(Φ*)≈m. In many implementations, a generative model is defined for each signal domain.

The difference between the simulated measurements and the actual measurements is referred to as a loss, and the fitting process generally reduces the loss until a threshold condition is reached. For example, the fitting process can be implemented to iteratively decrease the differences between the simulated measurements and the actual measurements and adjust the parameters accordingly in an attempt to find a set of parameters with a loss below a given threshold. Different loss functions, such as L1 and L2 loss functions, can be utilized. Depending on the parameter space and the implementation of the MMFMT fitter module, an outcome of the fitting may correspond to a global minimum or a local minimum.

In some implementations, the fitting process includes separate loss functions for each data signal. In such examples, the fitting process can be performed until reaching a threshold condition for an aggregate of the loss functions. The fitting process can include constraints to prevent undesired states of the facial model. For example, the fitting process can include regularizers and priors to prevent parameters that result in abrupt changes in mesh vertices from neighboring frames, skin intersecting with eyeballs, etc.

The MMFMT fitter module 116 can be implemented in various ways depending on the application. For example, the type of data signals utilized can depend on the available hardware, such as the available sensors on a wearable device. In some such examples, the wearable device is in the form of eyeglasses having various sensors, including an eye camera, an antenna, and a microphone. Multiples of each sensor may be implemented.

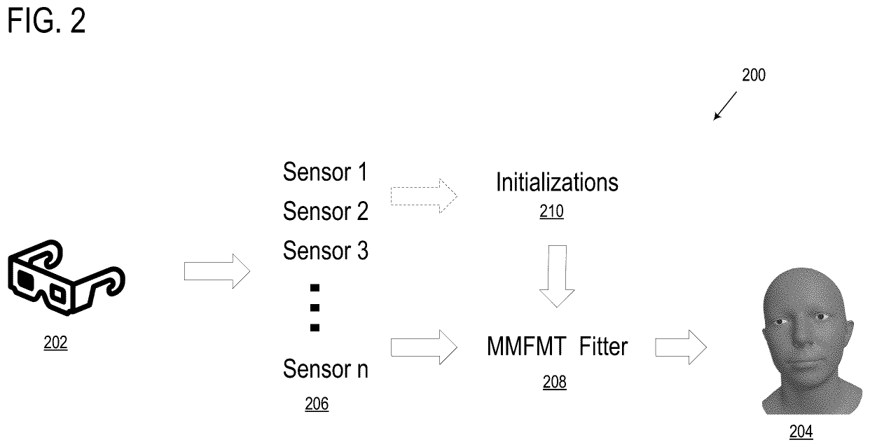

FIG. 2 schematically illustrates a diagram 200 showing an example process of converting multi-modal data signals from a head-mounted display (HMD) in the form of a pair of eyeglasses 202 into an expressive 3D facial model 204. In many implementations, the pair of eyeglasses 202 is a smart device for use in VR/AR/MR/applications. The pair of eyeglasses 202 includes various sensors 206 for providing multi-modal data signals that are fed into an MMFMT fitter module 208 along with initialization information 210 describing an initial state of a facial model. The MMFMT fitter module 208 may operate on a per-instance basis to determine a given expression 204 at a given time. As can readily be appreciated, different types of measurements and data formats can be utilized to determine the user's expression depending on the application and the available hardware. In some implementations, the MMFMT process includes at least the use of eye cameras, antennas, and a microphone for providing multi-modal data signals.

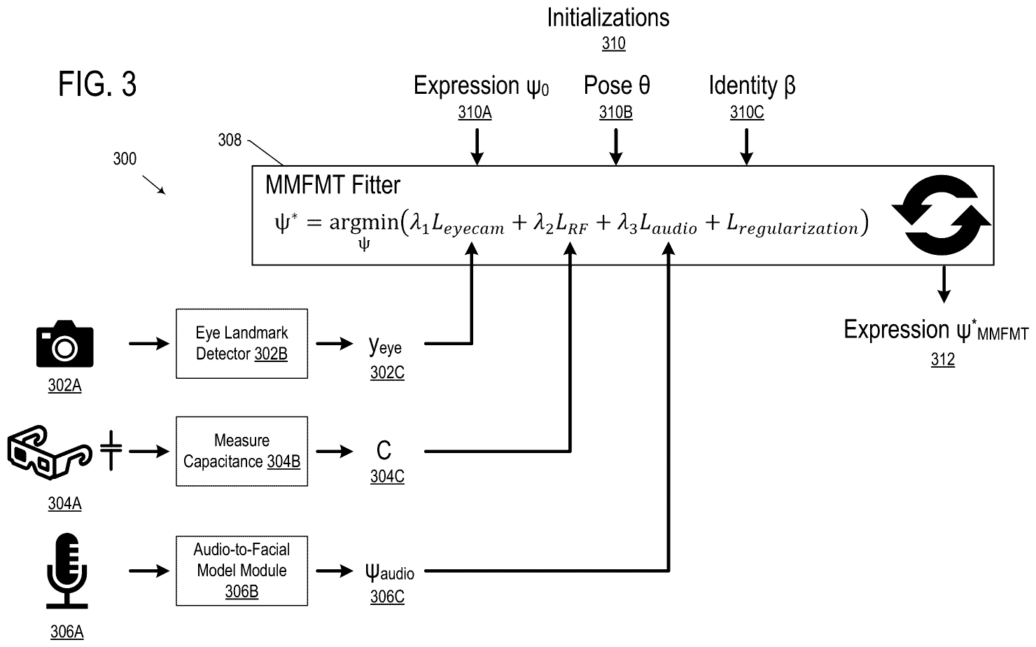

FIG. 3 schematically illustrates a diagram 300 showing an example process of determining expression parameters for a three-dimensional face at a given time instant using data signals from an eye camera 302A, an antenna 304A, and a microphone 306A. As described above, these sensors 302A-306A can be implemented on a wearable device such as smart eyeglasses. The sensors 302A-306A provide their respective data signals, which can be converted into an appropriate format that can be fed into an MMFMT fitter module 308. For example, the eye camera 302A produces an image that can be fed into an eye landmark detector module 302B to estimate and determine eye landmarks y_{eye} 302C. Measuring capacitance 304B from the antenna 304A can result in capacitance values C 304C. Audio data signals from the microphone 306A can be fed into an audio-to-facial expression module 306B to generate an audio expression parameter ψ_{audio} 306C.

The measurements 302C-306C from these sensors 302A-306A are fed into the MMFMT fitter module 308 along with a set of parameters 310 describing the initial state of the facial model. In the depicted diagram 300, the set of parameters 310 describing the initial state of the facial model includes parameters describing the initial expression ψ₀ 310A, initial pose θ 310B, and initial identity β 310C of the facial model. The MMFMT fitter module 308 may operate on a per-instance basis. For a given instance, the MMFMT fitter module 308 iteratively steps through the parameter space in an attempt to find an expression ψ* that results in the least amount of loss. In the depicted example, the expression ψ* is determined as

$$\\ {ψ}^{*} = {arg min}_{ψ} ( {λ}_{1} {L}_{eyecam} + {λ}_{2} {L}_{RF} + {λ}_{3} {L}_{audio} + {L}_{regularization} ) ,$$

where λ₁, λ₂, λ₃ are weights, L_{eyecam}, L_{RF}, and L_{audio} are loss functions, and L_{regularization} is a function for enforcing prior constraints.

The MMFMT fitter module 308 simulate measurements using the parameters 310 describing the initial state of the facial model. The type of simulated measurements is based on the data signals utilized. The loss functions in the MMFMT fitter module 308 receive the actual measurements (y_{eye} 302C, C 304C, and ψ_{audio} 306C) and the simulated measurements as inputs and compare the two sets to determine a loss. Smaller differences between the actual and simulated measurements result in smaller losses. The MMFMT fitter module 308 then updates the parameters 310 based on the calculated loss, and the fitting process is performed again in an iterative loop. The fitting process can be performed iteratively until a predetermined criterion is satisfied. For example, the iterative process can continue until the output of the loss functions is below a loss threshold. In some implementations, the predetermined criterion is met after a predetermined number of iterations is performed. Once the predetermined criterion is met, the MMFMT fitter module 308 outputs an expression parameter ψ*_{MMFMT} 312 for use in generating an expressive 3D facial model.

The different modalities utilized in generating an expressive avatar present different problems in handling the different data signals. For example, given an MMFMT model, the device implementing such a model could lack one or more of the data signals utilized in the model or the data signal could be missing at times. In such cases, the signals can be modeled with synthetics and can be plugged in whenever real data is missing.

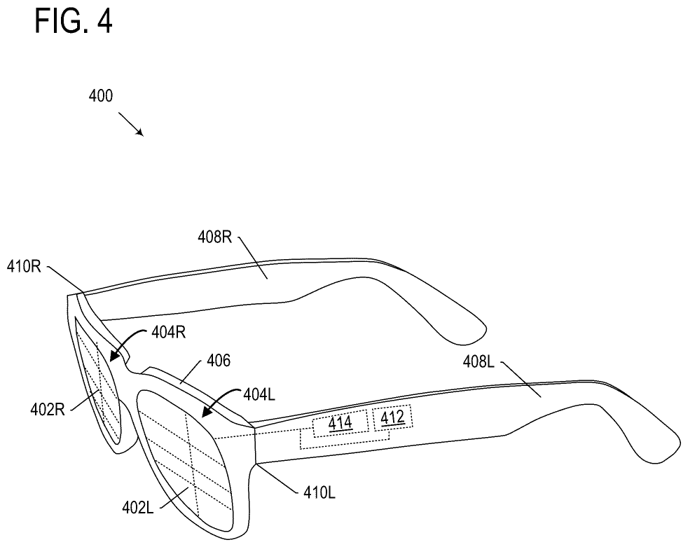

Another challenge includes the use of antennas on a wearable device and the modeling of their simulated measurements. In general, a change in expression leads to changes in the capacitive system between the antennas and the user, which is observed as a change in the measured capacitance values. For example, as the facial muscles move, the capacitances measured by the antennas may change based upon proximities of facial surfaces to corresponding antennas. FIG. 4 shows an example wearable device 400 that includes a plurality of antennas. As shown, the wearable device 400 includes a left antenna array 402L formed on a left lens 404L of the wearable device 400, and a right antenna array 402R formed on a right lens 404R of the wearable device 400. Each of left antenna array 402L and the right antenna array 402R includes a plurality of antennas each configured to sense a different region of a user's face. Each antenna is positioned proximate to a surface of the face and form a capacitance based upon a distance between the antenna and the surface of the face. In other examples, the wearable device 400 alternatively or additionally may include one or more antennas disposed on a frame 406 of the wearable device 400.

Left lens 404L and right lens 404R are supported by the frame 406, which is connected to side frames 408L, 408R via optional hinge joints 410L, 410R. Left include array 402L and right antenna array 402R are respectively schematically depicted by dashed lines on left lens 404L and right lens 404R, which indicate an arbitrary spatial arrangement of antennas. Other layouts may be implemented. The term “lens” is used herein to represent one or more optical components through which a real-world environment can be viewed. The term “lens” may include an optical combiner that combines virtual and real imagery, and/or one or more transparent optical components other than a combiner, such as a separate lens with or without optical power.

Each lens 404L, 404R includes an electrically insulating substrate that is at least partially optically transparent. For example, the substrate may include a glass, or an optically transparent plastic such as polycarbonate, polymethyl methacrylate (PMMA), polystyrene, polyethylene terephthalate (PET), cyclic olefin polymer, or other suitable material.

Antenna arrays 402L, 402R are formed from electrically conductive films that are at least partially optically transparent. The films may include one or more electrically conductive materials, such as indium tin oxide (ITO), silver nanowires, silver nanoparticles, carbon nanotubes, graphene, a mixture of two or more such materials (e.g., silver nanoparticle-ITO hybrid), and/or other suitable material(s). The film(s) may be formed via any suitable process, such as chemical vapor deposition, sputtering, atomic layer deposition, evaporation, or liquid phase application (e.g. spin-on, dip-coating, application by doctor-blade, etc.). Trenches formed between the antennas may be utilized for placement of conductive traces. As the conductive film may not be fully optically transparent in some examples, the use of relatively thinner films for the antennas may provide for greater transparency compared to relatively thicker coatings.

Wearable device 400 further includes a plurality of charge sensing circuits, schematically illustrated at 412. Each charge sensing circuit of the plurality of charge sensing circuits 412 is connected to a corresponding antenna. Each charge sensing circuit 412 is configured to determine the capacitance of a corresponding antenna, for example, by determining an amount of charge accumulated on the corresponding antenna resulting from application of a reference voltage.

Wearable device 400 further includes a controller 414. Controller 414 comprises, among other components, a logic subsystem and a storage subsystem that stores instructions executable by the logic subsystem to control the various functions of wearable device 400, including but not limited to the facial-tracking functions described herein.

Simulated measurements from the antennas can be computed by modeling the antennas and the user's face as a capacitive system. Geometry, material, sensor placement, etc. are all factors that affect the capacitance of the system. A relatively low complexity implementation of the finite element method can be used to measure the capacitance. However, such methods are non-differentiable and may be slow, for example operating at approximately 1200 frames/hour. Thus, in some implementations, the MMFMT model uses an approximation-based approach. One example approximation-based approach uses a parallel plate capacitor model. For a given antenna, the parallel plate capacitor model approach includes partitioning the antenna into triangles. Utilizing a triangle mesh of the 3D facial model, antenna-face triangle pairs are formed by finding the closest triangle on the mesh for each antenna triangle. Each antenna-face triangle pair can be treated as a parallel place capacitor. The capacitance C_{Δ} for each pair can then be determined as

$$\\ {C}_{△} = {ε}_{0} \frac{A}{d} ,$$

where ε₀ is the permittivity of free space, A is the area, and d is the distance between the pair of triangles. The capacitance values can be summed to determine the effective capacitance of the given antenna. In some implementations, a weighted sum is used to determine the effective capacitance of the given antenna.

Since the forward model will be called at each iteration of the fitting process, the computational speed of the model is a consideration. However, computations involved in the parallel plate capacitor model described above can present challenges. For example, wearable devices implementing such methods are typically small form factor devices. Power and size constraints of the available hardware may present issues in computational power. Techniques for simplifying the computations and lowering the amount of memory utilized can be performed to accommodate such use cases. For example, for a given antenna triangle, determining the closest face triangle can be simplified by comparing distances of only a candidate subset of face triangles. The candidate subset of face triangles can be computed beforehand by finding a predetermined number K of the closest candidate triangles for each antenna triangle under a zero expression condition. This reduces the search space for the closest triangle computation.

Depending on the hardware and capacitance model implemented, the simulated capacitance values may not match the hardware measurements. In such cases, a calibration step is performed to determine a mapping function that maps a given parallel plate capacitor simulated signal value to a hardware signal. In some implementations, a per-antenna linear fit mapping function is utilized (i.e., a linear regression is performed to map parallel plate capacitor simulated signal values to the hardware signals). Other types of mapping functions can be utilized depending on the application. Example methods include min-max normalization, joint-fitting, neural network-based fitting, etc.

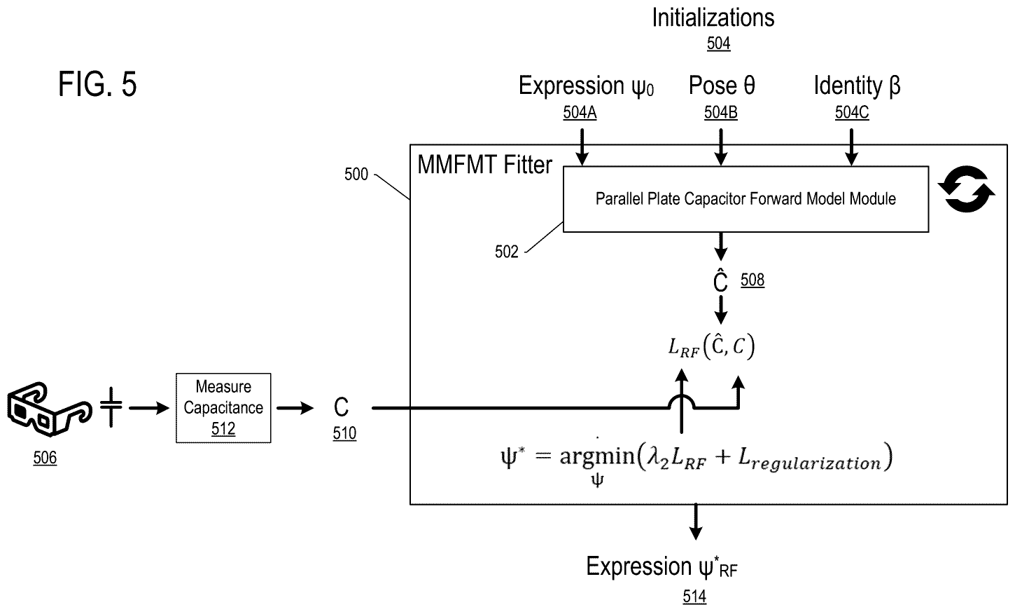

As described above, the MMFMT fitter module can be implemented using a forward model. The model is typically a generative model specific to signals in the given signal domain. The forward model takes in parameters defining the face and simulates measurements, which, in the case of data signals from the antennas, are simulated capacitance values. FIG. 5 shows an example MMFMT fitter module 500 implementing a parallel plate capacitor forward model 502. As shown, the parallel plate capacitor forward model 502 is implemented as a module that receives initialization data 504 as inputs. Initialization data 504 includes parameters describing the initial expression ψ₀ 504A, initial pose θ 504B, and initial identity β 504C of a facial model. Based on the initial facial model and the antennas of a wearable device 506, the parallel plate capacitor forward model module 502 can simulate capacitance measurements of the capacitive system, outputting simulated capacitance values Ĉ 508. Actual measurements 510 are computed by measuring the capacitance 512 across the antennas 506 of the wearable device while the user is wearing the wearable device. The simulated measurements 508 are compared against the actual measurements 510 using a loss function, and the parameters are adjusted based on the comparison through backpropagation. The process continues iteratively until a predetermined criterion is met. For example, the iterative process can continue until the output of the loss function is below a loss threshold. In some implementations, the predetermined criterion is met after a predetermined number of iterations is performed. Once the predetermined criterion is met, the MMFMT fitter module 500 outputs an expression parameter ψ*_{RF} 514 for use in generating an expressive 3D facial model.

Another set of sensors that can be utilized in MMFMT processes are eye cameras. Many wearable headsets or eyeglasses include cameras positioned towards the user's eye(s). Generally, these cameras are used for gaze estimation and eye tracking for various applications. MMFMT processes in accordance with the present disclosure can utilize such eye cameras to determine the expressions in the eye region of the face. Further, the eye cameras can also give reasonable priors for the expressions in the lower region of the face. For example, a face performing an “amazed” expression will include a set of expressions near the eye(s) and mouth that are similar across several “amazed” expressions. Thus, expressions near the eye(s) can be correlated to expressions near the mouth, and an expression in one area can be inferred by an expression in the other area.

Eye cameras can provide image data to the MMFMT model. To provide target metrics for the fitting process, eye landmarks are first determined from the image data. In some implementations, an eye landmark detector module is implemented to determine the eye landmarks. An eye landmark detector module can be developed by a training process using a synthetics training pipeline to regress a number of different landmarks on the eye. In some such examples, the training process regress eighty landmarks on the eye. These landmarks can then be used in the fitting process to fit the parameters.

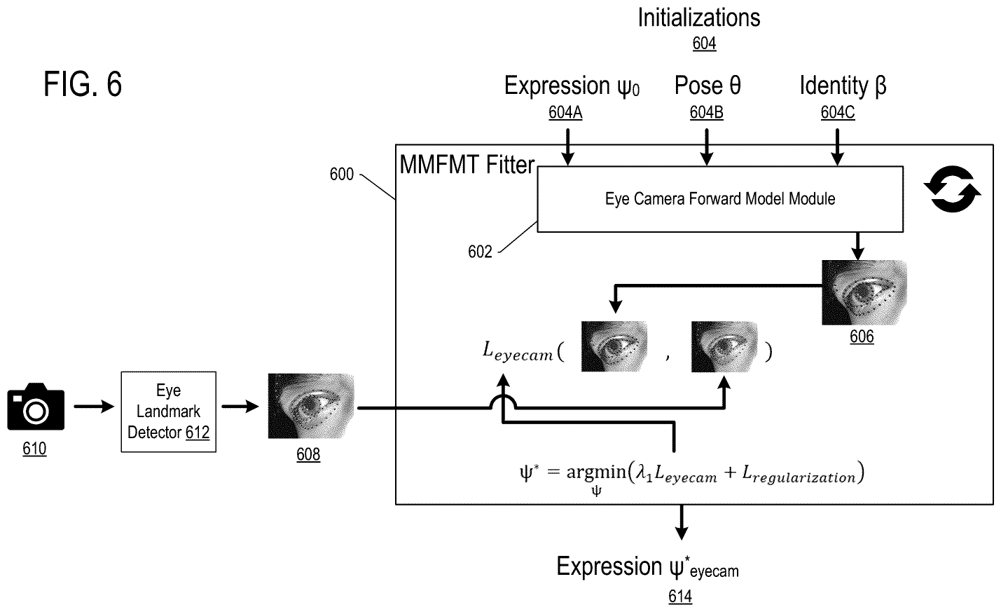

FIG. 6 shows an example MMFMT fitter module 600 implementing an eye camera forward model 602. As shown, the eye camera forward model 602 is implemented as a module that receives initialization data 604 as inputs. Initialization data 604 includes parameters describing the initial expression ψ₀ 604A, initial pose θ 604B, and initial identity β 604C of a facial model. Based on the initial facial model, the eye camera forward model 602 simulates eye landmarks 606. Actual eye landmarks 608 are determined using image data from one or more eye cameras 610 on a wearable device. An eye landmark detector module 612 is implemented to receive the image data and output eye landmarks 608. The simulated eye landmarks 606 are compared against the actual eye landmarks 608 using a loss function, and the parameters are adjusted based on the comparison through backpropagation. The process continues iteratively until a predetermined criterion is met. For example, the iterative process can continue until the output of the loss function is below a loss threshold. In some implementations, the predetermined criterion is met after a predetermined number of iterations is performed. Once the predetermined criterion is met, the MMFMT fitter module 600 outputs an expression parameter ψ*_{eyecam} 614 for use in generating an expressive 3D facial model.

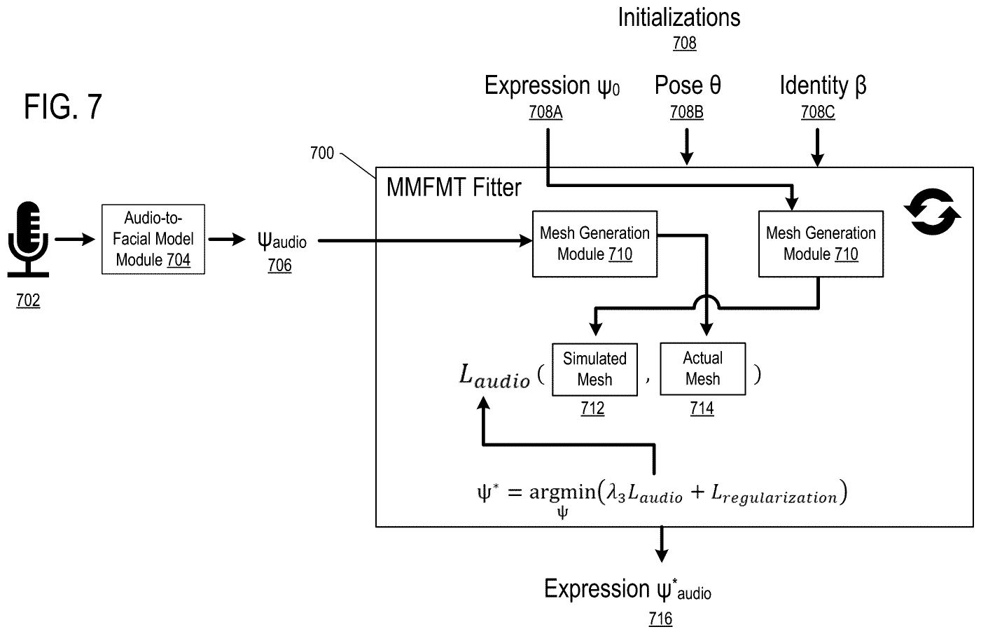

Another modality of data signals that can be utilized in the MMFMT process includes the use of audio data. FIG. 7 shows an example MMFMT fitter module 700 implementing a fitting process for audio data signals. Audio data signals are received from a microphone 702. The microphone 702 may be implemented on a wearable device. An audio-to-facial model module 704 is implemented to receive the audio data signals. The audio-to-facial model module 704 uses the audio data signals to generate an audio expression parameter ψ_{audio} 706.

The MMFMT fitter module 700 receives initialization data 708 as inputs. Initialization data 708 includes parameters describing the initial expression ψ₀ 708A, initial pose θ 708B, and initial identity β 708C of a facial model. A mesh generation module 710 can be utilized to generate a simulated face mesh 712 using the initialization data 708, including the initial expression ψ₀ 708A. Similarly, the mesh generation module 710 can be used to generate an actual face mesh 714 using the audio expression ψ_{audio} 706 and/or the initialization data 708. In some implementations, the simulated face mesh 712 and the actual face mesh 714 are generated using the initial identity β 708C parameter and their respective expression parameter. In further implementations, the initial pose θ 708B may also be used to generate the simulated face mesh 712 and the actual face mesh 714. The simulated face mesh 712 is compared against the actual face mesh 714 using a loss function, and the parameters are adjusted based on the comparison. The process continues iteratively until a predetermined criterion is met. For example, the iterative process can continue until the output of the loss function is below a loss threshold. In some implementations, the predetermined criterion is met after a predetermined number of iterations is performed. Once the predetermined criterion is met, the MMFMT fitter module 700 outputs an expression parameter ψ*_{audio} 716 for use in generating an expressive 3D facial model.

Combining multi-modal data signals from various sensors, such as those described above, provide for an improved framework for predicting a user's facial expression. Utilizing sensors with complementary properties with one another further improves upon the framework. For example, using a combination of antennas, eye cameras, and microphones provide lower errors (distance between the simulated and actual measurements) for most face regions compared to the use of any individual sensor. Certain sensors can be more reliable than other sensors for certain areas of the face. For example, the use of antennas performs well in the eye, cheek, and nose regions. On the other hand, the use of antennas, eye cameras, and/or microphones may be less predictive with regard to the ear region.

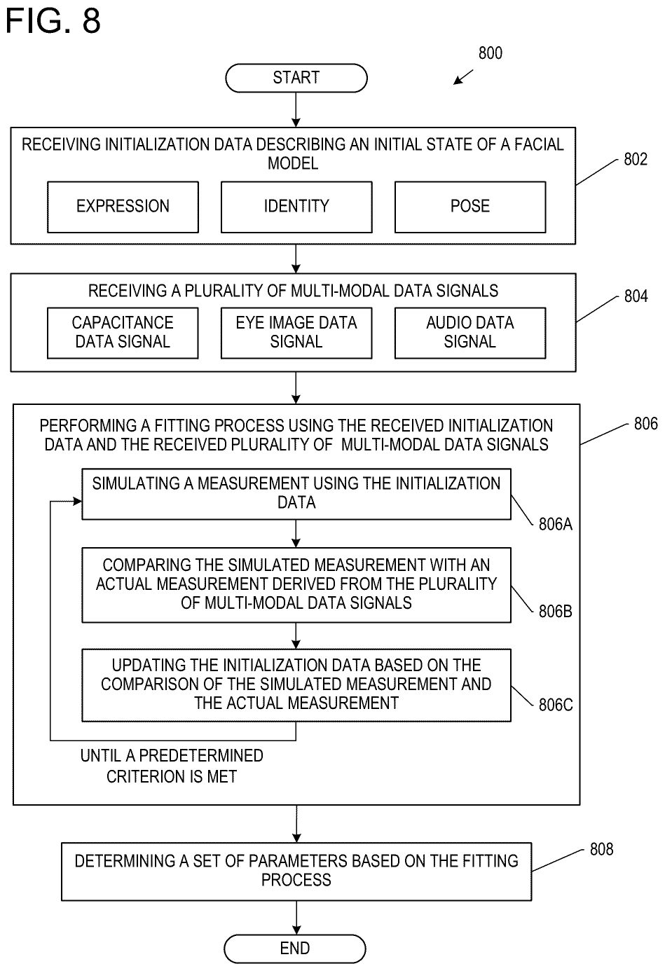

FIG. 8 shows a flow diagram illustrating an example method 800 for generating an expressive facial model using a multi-modal 3D face modeling and tracking process. At 802, the method 800 includes receiving initialization data describing an initial state of a facial model. Different types of initialization data can be implemented depending on the application. In some implementations, the initialization data includes a set of initial parameters describing an initial state of the facial model. For example, the initialization data can include a parameter ψ₀ describing the expression of the initial state of the facial model. The initialization data can also include a parameter β describing the identity of the initial state of the facial model, such as information regarding head shape, size, etc. The initialization data can also include a parameter θ describing the pose of the initial state of the facial model, such as information regarding the rotations and translations for the head, neck, and eyes of the facial model. The initial state utilized can depend on the application. For example, the initial state can be a zero expression state. In some implementations, the initial state is the previous state of the facial model in a real-time application. In other implementations, the initial state is generated by passing an audio data signal through an audio-to-facial model module.

At 804, the method 800 includes receiving a plurality of multi-modal data signals. Different types of data signals can be implemented depending on the application. In some implementations, the plurality of multi-modal data signals includes a first data signal received from an eye camera, a second data signal received from a set of antennas, and a third data signal received from a microphone. Data signals from the eye camera can be received in the form of image data. In further implementations, the image data from the eye camera is used to derive a set of eye landmarks y_{eye}. The eye landmarks y_{eye} can be determined using an eye landmark detector module. Data signals from the set of antennas can include a capacitance measurement from the set of antennas. Data signals from the microphone can be received in the form of audio data. In further implementations, the audio data is used to derive an expression ψ_{audio}. The audio expression ψ_{audio} can be determined using an audio-to-facial model module.

At 806, the method 800 includes performing a fitting process using the received initialization data and the received plurality of multi-modal data signals. The fitting process can include solving

$$\\ {ψ}^{*} = {arg min}_{ψ} ( {λ}_{1} {L}_{eyecam} + {λ}_{2} {L}_{RF} + {λ}_{3} {L}_{audio} + {L}_{regularization} ) ,$$

where λ₁, λ₂, λ₃ are weights, L_{eyecam}, L_{RF}, and L_{audio} are loss functions, and L_{regularization} is a function for enforcing prior constraints.

The fitting process can be performed using an iterative learning process. An iteration of the process can include simulating a measurement using the received initialization data, at substep 806A. Different simulation techniques can be performed depending on the type of data signals utilized. For example, in implementations where the multi-modal data signals include a data signal received from a set of antennas, a capacitance value can be simulated using a parallel plate capacitor model. Such processes can include partitioning an antenna within the set of antennas into a plurality of antenna triangles. For each antenna triangle, a face triangle that is closest to the antenna triangle is determined based on a predetermined distance metric. Example distance metrics include a Euclidean distance metric. The face triangle is a triangle within a triangle mesh of the initial state of the facial model. For each antenna-face triangle pair, a capacitance value C_{Δ} is calculated as

$$\\ {C}_{△} = {ε}_{0} \frac{A}{d} ,$$

where ε₀ is the permittivity of free space, A is the area, and d is the distance between the pair of triangles. A simulated capacitance C_{simulated} can be calculated based on the calculated capacitance values C_{Δ} of each of the antenna-face triangle pair. In some implementations, C_{simulated} is calculated by summing up the capacitance values C_{Δ} of each of the antenna-face triangle pair. In some implementations, C_{simulated} is calculated using a weighted sum of the capacitance values C_{Δ} of each of the antenna-face triangle pair.

At 806B, the iteration includes comparing the simulated measurement with an actual measurement derived from the plurality of multi-modal data signals. The comparison can include finding the difference between the two measurements using a loss function.

At 806C, the iteration includes updating the initialization data based on the comparison of the simulated measurement and the actual measurement. The iterative process can continue until the comparison of the simulated measurement and the actual measurement reaches a predetermined threshold. For example, the iterative process can terminate to output a set of parameters when the difference between the simulated measurement and the actual measurement based on a loss function is below a predetermined loss threshold. The fitting process can be implemented using various neural network architectures, including convolutional neural networks (CNNs), recurrent neural networks (RNNs), bi-directional long short term memory RNNs, encoder-decoder transformers, encoder-only transformers, Siamese networks, etc. Additionally or alternatively, the fitting process can be implemented using various non-linear optimizers, including non-linear optimizers using Hessian, quasi-Newton, gradient descent, and/or Levenberg-Marquardt type methods.

At 808, the method 800 includes determining a set of parameters based on the fitting process, wherein the determined set of parameters describing an updated state of the facial model. In some implementations, the set of determined parameters include an identity parameter that is similar to the identity parameter of the initial set of parameters.

The methods and processes described herein may be tied to a computing system of one or more computing devices. In particular, such methods and processes may be implemented as a computer-application program or service, an application-programming interface (API), a library, and/or other computer-program product.

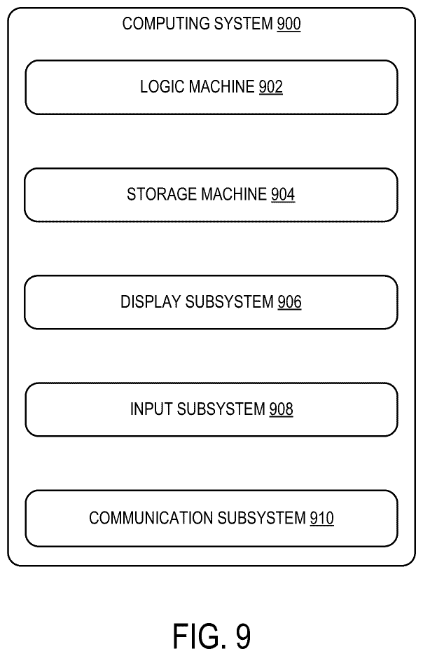

FIG. 9 schematically shows a non-limiting embodiment of a computing system 900 that can enact one or more of the methods and processes described above. Computing system 900 is shown in simplified form. Computing system 900 may take the form of one or more personal computers, server computers, tablet computers, home-entertainment computers, network computing devices, gaming devices, mobile computing devices, mobile communication devices (e.g., smart phone), and/or other computing devices.

Computing system 900 includes a logic machine 902 and a storage machine 904. Computing system 900 may optionally include a display subsystem 906, input subsystem 908, communication subsystem 910, and/or other components not shown in FIG. 9.

Logic machine 902 includes one or more physical devices configured to execute instructions. For example, the logic machine 902 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine 902 may include one or more processors configured to execute software instructions. Additionally or alternatively, the logic machine 902 may include one or more hardware or firmware logic machines configured to execute hardware or firmware instructions. Processors of the logic machine 902 may be single-core or multi-core, and the instructions executed thereon may be configured for sequential, parallel, and/or distributed processing. Individual components of the logic machine 902 optionally may be distributed among two or more separate devices, which may be remotely located and/or configured for coordinated processing. Aspects of the logic machine 902 may be virtualized and executed by remotely accessible, networked computing devices configured in a cloud-computing configuration.

Storage machine 904 includes one or more physical devices configured to hold instructions executable by the logic machine 902 to implement the methods and processes described herein. When such methods and processes are implemented, the state of storage machine 904 may be transformed—e.g., to hold different data.

Storage machine 904 may include removable and/or built-in devices. Storage machine 904 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 904 may include volatile, nonvolatile, dynamic, static, read/write, read-only, random-access, sequential-access, location-addressable, file-addressable, and/or content-addressable devices.

It will be appreciated that storage machine 904 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 902 and storage machine 904 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 900 implemented to perform a particular function. In some cases, a module, program, or engine may be instantiated via logic machine 902 executing instructions held by storage machine 904 It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 906 may be used to present a visual representation of data held by storage machine 904. This visual representation may take the form of a graphical user interface (GUI). As the herein described methods and processes change the data held by the storage machine 904, and thus transform the state of the storage machine 904, the state of display subsystem 906 may likewise be transformed to visually represent changes in the underlying data. Display subsystem 906 may include one or more display devices utilizing virtually any type of technology. Such display devices may be combined with logic machine 902 and/or storage machine 904 in a shared enclosure, or such display devices may be peripheral display devices.

When included, input subsystem 908 may comprise or interface with one or more user-input devices such as a keyboard, mouse, touch screen, or game controller. In some embodiments, the input subsystem 908 may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 910 may be configured to communicatively couple computing system 900 with one or more other computing devices. Communication subsystem 910 may include wired and/or wireless communication devices compatible with one or more different communication protocols. As non-limiting examples, the communication subsystem 910 may be configured for communication via a wireless telephone network, or a wired or wireless local- or wide-area network. In some embodiments, the communication subsystem 910 may allow computing system 900 to send and/or receive messages to and/or from other devices via a network such as the Internet.

Another aspect includes a computer system for generating an expressive avatar using multi-modal three-dimensional face modeling and tracking. The computer system includes a processor coupled to a storage system that stores instructions, which, upon execution by the processor, cause the processor to receive initialization data describing an initial state of a facial model. The instructions further cause the processor to receive a plurality of multi-modal data signals. The instructions further cause the processor to perform a fitting process using the received initialization data and the received plurality of multi-modal data signals. The instructions further cause the processor to determine a set of parameters based on the fitting process, wherein the determined set of parameters describes an updated state of the facial model. In this aspect, additionally or alternatively, performing the fitting process includes iteratively performing simulating a measurement using the initialization data, comparing the simulated measurement with an actual measurement derived from the plurality of multi-modal data signals, and updating the initialization data based on the comparison of the simulated measurement and the actual measurement. In this aspect, additionally or alternatively, the set of parameters is determined based on the updated initialization data of an iteration of the fitting process where the comparison of the simulated measurement and the actual measurement satisfies a loss threshold. In this aspect, additionally or alternatively, the plurality of multi-modal data signals comprises a first data signal received from an eye camera, a second data signal received from an antenna, and a third data signal received from a microphone. In this aspect, additionally or alternatively, performing the fitting process comprises solving

$$\\ {ψ}^{*} = {arg min}_{ψ} ( {λ}_{1} {L}_{eyecam} + {λ}_{2} {L}_{RF} + {λ}_{3} {L}_{audio} + {L}_{regularization} ) ,$$

where λ₁, λ₂, λ₃ are weights, L_{eyecam}, L_{RF}, and L_{audio} are loss functions, and L_{regularization} is a function for enforcing prior constraints. In this aspect, additionally or alternatively, the initialization data includes a set of initial parameters describing an identity, an expression, and a pose of the facial model. In this aspect, additionally or alternatively, the determined set of parameters has a similar identity parameter as the set of initial parameters. In this aspect, additionally or alternatively, the plurality of multi-modal data signals includes a data signal received from a set of antennas, and performing the fitting process includes simulating a capacitance value using a parallel plate capacitor model. In this aspect, additionally or alternatively, the storage system stores further instructions, which, upon execution by the processor, cause the processor to perform a calibration process to map simulated capacitance values to actual capacitance values. In this aspect, additionally or alternatively, simulating the capacitance value using the parallel plate capacitor model includes partitioning an antenna within the set of antennas into a plurality of antenna triangles, determining a plurality of antenna-face triangle pairs by, for each antenna triangle, determining a face triangle that is closest to the antenna triangle based on a distance metric, wherein the face triangle is part of a triangle mesh of the initial state of the facial model, calculating a capacitance for each of the plurality of antenna-face triangle pairs, and calculating the simulated capacitance value based on the calculated capacitances for each of the plurality of antenna-face triangle pairs.

Another aspect includes a method for generating an expressive avatar using multi-modal three-dimensional face modeling and tracking. The method includes receiving initialization data describing an initial state of a facial model. The method further includes receiving a plurality of multi-modal data signals. The method further includes performing a fitting process using the received initialization data and the received plurality of multi-modal data signals. The method further includes determining a set of parameters based on the fitting process, wherein the determined set of parameters describes an updated state of the facial model. In this aspect, additionally or alternatively, performing the fitting process includes iteratively performing simulating a measurement using the initialization data, comparing the simulated measurement with an actual measurement derived from the plurality of multi-modal data signals, and updating the initialization data based on the comparison of the simulated measurement and the actual measurement. In this aspect, additionally or alternatively, the set of parameters is determined based on the updated initialization data of an iteration of the fitting process where the comparison of the simulated measurement and the actual measurement satisfies a loss threshold. In this aspect, additionally or alternatively, the plurality of multi-modal data signals includes a first data signal received from an eye camera, a second data signal received from an antenna, and a third data signal received from a microphone. In this aspect, additionally or alternatively, performing the fitting process comprises solving

$$\\ {ψ}^{*} = {arg min}_{ψ} ( {λ}_{1} {L}_{eyecam} + {λ}_{2} {L}_{RF} + {λ}_{3} {L}_{audio} + {L}_{regularization} ) ,$$

where λ₁, λ₂, λ₃ are weights, L_{eyecam}, L_{RF}, and L_{audio} are loss functions, and L_{regularization} is a function for enforcing prior constraints. In this aspect, additionally or alternatively, the initialization data comprises a set of initial parameters describing an identity, an expression, and a pose of the facial model. In this aspect, additionally or alternatively, the determined set of parameters has similar identity and pose parameters as the set of initial parameters. In this aspect, additionally or alternatively, the plurality of multi-modal data signals comprises a data signal received from a set of antennas, and wherein performing the fitting process includes simulating a capacitance value using a parallel plate capacitor model. In this aspect, additionally or alternatively, simulating the capacitance value using the parallel plate capacitor model includes partitioning a capacitive antenna within the set of antennas into a plurality of antenna triangles, determining a plurality of antenna-face triangle pairs by, for each antenna triangle, determining a face triangle that is closest to the antenna triangle based on a distance metric, wherein the face triangle is part of a triangle mesh of the initial state of the facial model, calculating a capacitance for each of the plurality of antenna-face triangle pairs, and calculating the simulated capacitance value based on the calculated capacitances for each of the plurality of antenna-face triangle pairs.

Another aspect includes a head-mounted display for generating an expressive avatar using multi-modal three-dimensional face modeling and tracking. The wearable device includes a set of antennas, a set of eye cameras, a microphone, and a processor coupled to a storage system that stores instructions, which, upon execution by the processor, cause the processor to receive initialization data describing an initial state of a facial model. The instructions further cause the processor to receive a plurality of multi-modal data signals including a first data signal from the set of antennas, a second data signal from the set of eye cameras, and a third data signal from the microphone. The instructions further cause the processor to perform a fitting process using the received initialization data and the received plurality of multi-modal data signals by iteratively performing simulating a measurement using the initialization data, comparing the simulated measurement with an actual measurement derived from the plurality of multi-modal data signals, and updating the initialization data based on the comparison of the simulated measurement and the actual measurement. The instructions further cause the processor to determine a set of parameters based on the fitting process, wherein the determined set of parameters describes an updated state of the facial model.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computer system for generating an expressive avatar using multi-modal three-dimensional face modeling and tracking, the computer system comprising:
a processor coupled to a storage system that stores instructions, which, upon execution by the processor, cause the processor to:
receive initialization data describing an initial state of a facial model;
receive a plurality of multi-modal data signals;
perform a fitting process using the received initialization data and the received plurality of multi-modal data signals; and
determine a set of parameters based on the fitting process, wherein the determined set of parameters describes an updated state of the facial model.

2. The computer system of claim 1, wherein performing the fitting process comprises iteratively performing:
simulating a measurement using the initialization data;
comparing the simulated measurement with an actual measurement derived from the plurality of multi-modal data signals; and
updating the initialization data based on the comparison of the simulated measurement and the actual measurement.

3. The computer system of claim 2, wherein the set of parameters is determined based on the updated initialization data of an iteration of the fitting process where the comparison of the simulated measurement and the actual measurement satisfies a loss threshold.

4. The computer system of claim 1, wherein the plurality of multi-modal data signals comprises a first data signal received from an eye camera, a second data signal received from an antenna, and a third data signal received from a microphone.

5. The computer system of claim 4, wherein performing the fitting process comprises solving
$$\\ {ψ}^{*} = {arg min}_{ψ} ( {λ}_{1} {L}_{eyecam} + {λ}_{2} {L}_{RF} + {λ}_{3} {L}_{audio} + {L}_{regularization} ) ,$$
where λ₁, λ₂, λ₃ are weights, L_{eyecam}, L_{RF}, and L_{audio} are loss functions, and L_{regularization} is a function for enforcing prior constraints.

6. The computer system of claim 1, wherein the initialization data comprises a set of initial parameters describing an identity, an expression, and a pose of the facial model.

7. The computer system of claim 6, wherein the determined set of parameters has a similar identity parameter as the set of initial parameters.

8. The computer system of claim 1, wherein the plurality of multi-modal data signals comprises a data signal received from a set of antennas, and wherein performing the fitting process includes simulating a capacitance value using a parallel plate capacitor model.

9. The computer system of claim 8, wherein the storage system stores further instructions, which, upon execution by the processor, cause the processor to:
perform a calibration process to map simulated capacitance values to actual capacitance values.

10. The computer system of claim 8, wherein simulating the capacitance value using the parallel plate capacitor model comprises:
partitioning an antenna within the set of antennas into a plurality of antenna triangles;
determining a plurality of antenna-face triangle pairs by:
for each antenna triangle, determining a face triangle that is closest to the antenna triangle based on a distance metric, wherein the face triangle is part of a triangle mesh of the initial state of the facial model;
calculating a capacitance for each of the plurality of antenna-face triangle pairs; and
calculating the simulated capacitance value based on the calculated capacitances for each of the plurality of antenna-face triangle pairs.

11. A method for generating an expressive avatar using multi-modal three-dimensional face modeling and tracking, the method comprising:
receiving initialization data describing an initial state of a facial model;
receiving a plurality of multi-modal data signals;
performing a fitting process using the received initialization data and the received plurality of multi-modal data signals; and
determining a set of parameters based on the fitting process, wherein the determined set of parameters describes an updated state of the facial model.

12. The method of claim 11, wherein performing the fitting process comprises iteratively performing:
simulating a measurement using the initialization data;
comparing the simulated measurement with an actual measurement derived from the plurality of multi-modal data signals; and
updating the initialization data based on the comparison of the simulated measurement and the actual measurement.

13. The method of claim 12, wherein the set of parameters is determined based on the updated initialization data of an iteration of the fitting process where the comparison of the simulated measurement and the actual measurement satisfies a loss threshold.

14. The method of claim 11, wherein the plurality of multi-modal data signals comprises a first data signal received from an eye camera, a second data signal received from an antenna, and a third data signal received from a microphone.

15. The method of claim 14, wherein performing the fitting process comprises solving
$$\\ {ψ}^{*} = {arg min}_{ψ} ( {λ}_{1} {L}_{eyecam} + {λ}_{2} {L}_{RF} + {λ}_{3} {L}_{audio} + {L}_{regularization} ) ,$$
where λ₁, λ₂, λ₃ are weights, L_{eyecam}, L_{RF}, and L_{audio} are loss functions, and L_{regularization} is a function for enforcing prior constraints.

16. The method of claim 11, wherein the initialization data comprises a set of initial parameters describing an identity, an expression, and a pose of the facial model.

17. The method of claim 16, wherein the determined set of parameters has similar identity and pose parameters as the set of initial parameters.

18. The method of claim 11, wherein the plurality of multi-modal data signals comprises a data signal received from a set of antennas, and wherein performing the fitting process includes simulating a capacitance value using a parallel plate capacitor model.

19. The method of claim 18, wherein simulating the capacitance value using the parallel plate capacitor model comprises:
partitioning a capacitive antenna within the set of antennas into a plurality of antenna triangles;
determining a plurality of antenna-face triangle pairs by:
for each antenna triangle, determining a face triangle that is closest to the antenna triangle based on a distance metric, wherein the face triangle is part of a triangle mesh of the initial state of the facial model;
calculating a capacitance for each of the plurality of antenna-face triangle pairs; and
calculating the simulated capacitance value based on the calculated capacitances for each of the plurality of antenna-face triangle pairs.

20. A head-mounted display for generating an expressive avatar using multi-modal three-dimensional face modeling and tracking, the wearable device comprising:
a set of antennas;
a set of eye cameras;
a microphone; and
a processor coupled to a storage system that stores instructions, which, upon execution by the processor, cause the processor to:
receive initialization data describing an initial state of a facial model;
receive a plurality of multi-modal data signals comprising a first data signal from the set of antennas, a second data signal from the set of eye cameras, and a third data signal from the microphone;
perform a fitting process using the received initialization data and the received plurality of multi-modal data signals by iteratively performing:
simulating a measurement using the initialization data;
comparing the simulated measurement with an actual measurement derived from the plurality of multi-modal data signals; and
updating the initialization data based on the comparison of the simulated measurement and the actual measurement; and
determine a set of parameters based on the fitting process, wherein the determined set of parameters describes an updated state of the facial model.
